(19) United States
(12) Patent Application Publication
(10) Pub. No.: US 2018/0308042 A1
(43) Pub. Date: Oct. 25, 2018

(54) PRODUCT MONITORING SYSTEM AND METHOD USING A MULTIPLE CHIP RFID TAG

(71) Applicant: Walmart Apollo, LLC, Bentonville, AR (US)

(72) Inventors: Alvin S. Taulbee, Springdale, AR (US); Jeremy R. Tingler, Bentonville, AR (US); Steven J. Lewis, Bentonville, AR (US); Nicholaus A. Jones, Fayetteville, AR (US)

(21) Appl. No.: 15/958,114

(22) Filed: Apr. 20, 2018

Related U.S. Application Data
(60) Provisional application No. 62/489,640, filed on Apr. 25, 2017.

(51) Int. Cl. G06Q 10/08; G06K 7/10; G06K 19/07; G06K 19/077; G06K 19/073

(52) U.S. Cl. CPC G06Q 10/087; G06K 7/10415; G06K 7/10108; G06K 19/07309; G06K 19/0721; G06K 19/07758; G06K 19/0723

(57) ABSTRACT

In some embodiments, system, apparatuses, and methods are provided herein useful to monitoring a product as the product leaves a facility. In some embodiments, a system comprises an RFID tag, wherein the RFID tag is associated with the product, and wherein the RFID tag includes a first chip and a second chip, a first of the two chips set to a first filter ID, an RFID tag reader, the RFID tag reader located near an exit of the facility and configured to read only RFID tags in the first filter ID, and a control circuit communicatively coupled to the RFID tag reader, the control circuit configured to receive, from the RFID tag reader based on a read of the first chip, an indication of the RFID tag, and log, based on the indication of the RFID tag, that the product has left the facility.

### CROSS-REFERENCE TO RELATED APPLICATION

This application claims the benefit of U.S. Provisional Application No. 62/489,640 filed Apr. 25, 2017, which is incorporated herein by reference in its entirety.

### TECHNICAL FIELD

This invention relates generally to radio frequency identification (RFID) technology and, more specifically, to RFID technology and inventory management.

### BACKGROUND

Many stores and businesses use radio frequency identification (RFID) technology for inventory management purposes. For example, products in a warehouse or retail environment can include RFID tags. RFID readers are used to read the tags and keep track of the products on a shelf, in a stockroom, on a sales floor, etc. While the current use of RFID technology is useful in inventory management, it does have some drawbacks. For example, once an RFID tag is energized, it will remain in a specific state (i.e., a persistent) state for a predefined period of time. This predefined period of time is based on a session for the RFID tag. After the predefined period of time, it will move to a new state, or revert back to the original state. Oftentimes, after being read, the RFID tag will transition to a state in which it will not be read. That is, the RFID tag enters a state in which it will not be read for a predefined period of time. While this prevents multiple reads of the same tag during an inventory period, it presents a difficulty if the goal is to read the tag twice, for example, by two distinct RFID readers. That is, if, after being read, the RFID tag enters a state in which it will not be read for the predefined period of time, a subsequent scan conducted during the predetermined period of time will not read the RFID tag. Consequently, while the state-switching aspect of RFID tags is beneficial in some circumstances (e.g., preventing duplicative reads), it can be a hindrance in others (e.g., subsequent reads in relatively quick succession).

### BRIEF DESCRIPTION OF THE DRAWINGS

Disclosed herein are embodiments of systems, apparatuses, and methods pertaining to monitoring a product as the product leaves a facility. This description includes drawings, wherein:

FIG. 1 depicts a product 102 including an RFID tag 104 having two chips, a first chip 110 and a second chip 112, according to some embodiments;

FIG. 2 is a block diagram depicting a system 200 for monitoring a product as the product leaves a facility; and

FIG. 3 is a flow diagram depicting example operations for monitoring a product as the product leaves a facility, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to monitoring a product as the product leaves a facility. In some embodiments, a system for monitoring a product as the product leave a facility comprises an RFID tag, wherein the RFID tag is associated with the product, and wherein the RFID tag includes a first chip and a second chip, the first chip set to a first filter ID, an RFID tag reader, the RFID tag reader located near an exit of the facility and configured to read only RFID tags in the first filter ID, and a control circuit communicatively coupled to the RFID tag reader, the control circuit configured to receive, from the RFID tag reader based on a read of the first chip, an indication of the RFID tag, and log, based on the indication of the RFID tag, that the product has left the facility.

As previously discussed, RFID technology can be useful in inventory management. For example, instead of an employee counting and cataloging items on a shelf in a retail facility, the employee can simply use an RFID reader to read the RFID tags of items on the shelf In this manner, RFID technology can increase accuracy, and decreases costs, of inventory management. To prevent RFID tags from being read duplicatively, RFID tags, after being read, will switch to a different state. Once in this new state, the RFID tag will not be read by the RFID reader. While this behavior can increase the accuracy of inventory management in some cases, it can decrease the accuracy in other cases. Specifically, this state-switching behavior is problematic when a subsequent read is desired shortly after an initial read. As one example, in a retail environment, a product's RFID tag may be read at checkout, causing the RFID tag to enter a state in which the RFID tag will no longer be read. If the RFID tag is still in a state in which it will not be read when the customer exits the retail facility, an RFID reader located near the exit of the retail facility will not read the RFID tag as the customer exits. Oftentimes this “exit read” is the most important read for inventory management. RFID tags associated with products are often read when the products are shipped to a retail facility, loaded into a stockroom or onto a sales floor, and purchased. Accordingly, there exist several opportunities for the RFID tags to be read before the products exit the retail facility. However, there is only one opportunity to read an RFID tag while the product exits the retail facility: as the product exits the retail facility. If this exit read is missed, it is difficult to know that the product has left the facility.

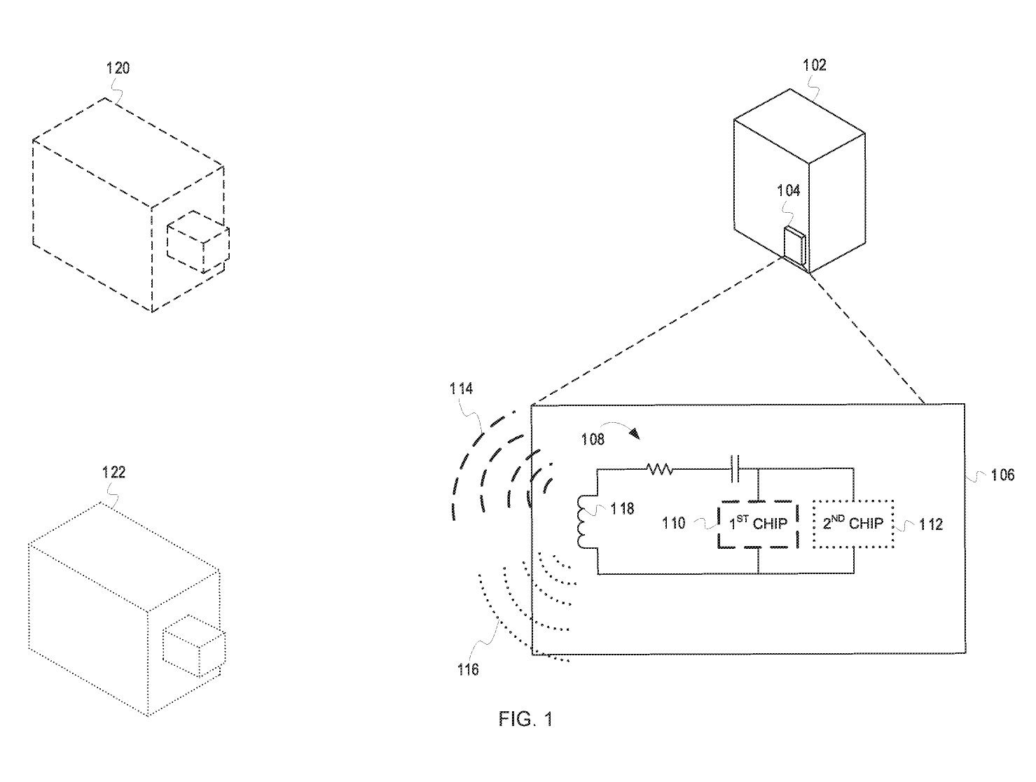

Described herein are systems, methods, and apparatuses that seek to eliminate or minimize the occurrence of RFID tags failing to be scanned as they exit the retail facility. In some embodiments, RFID tags including two chips are utilized in concert with exit RFID readers. One of the two chips is programmed to remain in a specific state and the exit RFID readers are configured to read only tags in the specific state. In this regard, the first chip should always be in a state in which it will be read by the exit RFID reader. Additionally, the second of the two chips can switch between the states normally so that the second of the two chips can be used for other inventory purposes. Because of this dual chip nature, the benefits of a state-switching RFID tag and a single-state RFID tag can be realized in the same RFID tag. The discussion of FIG. 1 provides and overview of an RFID tag having multiple chips.

FIG. 1 depicts a product 102 including an RFID tag 104 having two chips, a first chip 110 and a second chip 112, according to some embodiments. The RFID tag 104 can be passive or active and is affixed or otherwise incorporated with the product 102. A frame 106 includes an expanded, pseudo-schematic view of circuitry 108 of the RFID tag 104. It should be noted that the circuitry 108 is a simplified depiction of the actual components of the RFID tag 104. The circuitry 108 includes, among other components such as resistors and capacitors, an antenna 118 (e.g., an inductor, as depicted in FIG. 1), the first chip 110, and the second chip 112. The first chip 110 and the second chip 112 are integrated circuits and include memory. As depicted in FIG. 1, each of the first chip 110 and the second chip 112 are communicatively coupled to the antenna 118. As configured, both the first chip 110 and the second chip 112 can receive energy transmitted by an RFID reader 120 and transmit energy to the RFID reader 120. Although the first chip 110 and the second chip 112 are depicted as being in parallel with one another, such an arrangement is not required. Similarly, although the circuitry 108 depicted in FIG. 1 includes only a single antenna 118, in some embodiments, the circuitry 108 can include multiple antennas. For example, each of the first chip 110 and the second chip 112 can be coupled to independent antennas.

In some embodiments, the first chip 110 and the second chip 112 are serialized with the same identifier (i.e., a common identifier). In such embodiments, a read of the first chip 110 and a read of the second chip 112 will be indistinguishable such that a read of either chip identifies the RFID tag 104. Although each of the first chip 110 and the second chip 112 are serialized with the same identifier, each chip is set to a different filter ID (e.g., different states). For example, the first chip 110 can be set to a first state, such that only RFID readers, such as the first RFID reader 120, read information transmitted by the first chip 110. That is, the first RFID reader 120 is configured to read only RFID tags in the first state and therefore only read indications of RFID tags in the first state. This is depicted by the hashed lines used to represent the first chip 110, the first RFID reader 120, and the first transmission 114 associated with the first chip 110. Similarly, the second chip 112 can be set to a second state, or allowed to switch between states, so that a second RFID reader 122 is capable of reading the RFID tag 104 based on transmissions from the second chip 112. This is depicted by the dotted lines used to represent the second chip 112, the second RFID reader 122, and the second transmission 116 associated with the first chip 110. In some embodiments, the second chip 112 can be programmed to alternate between the states (i.e., behave like a typical RFID tag) so that it can be read by a general purpose RFID reader.

The RFID tag 104 having two chips can be useful for inventory management purposes. For example, the first chip 110 can be set to a first state, such as State B of Session 0 of the EPC GEN2 Standard, and the second chip 112 can be allowed to switch between the states as do typical RFID tags. Further, the first RFID reader 120 can be configured to read only RFID tags in State A and the second RFID reader 122 can be configured to read as do typical RFID readers (i.e., in multiple states). In a retail environment, the first RFID reader 120 is located near an exit and performs exit reads, while the second RFID reader 122 can be a number of RFID readers that are used to read RFID tags throughout the retail facility (e.g., in product display units, in the stockroom, at point-of-sale (POS) terminals, etc.). In this regard, if the RFID tag 104 is read by the second RFID reader 122 while the product 102 is in the retail facility which causes the second chip 112 to enter a different state (e.g., enter State B from State A), it will not impact the first RFID reader's 120 ability to read the first chip 110. Accordingly, the first RFID reader 120 will read the RFID tag 104 regardless of time since the second chip 112 was last read, ensuring that the exit read is not missed.

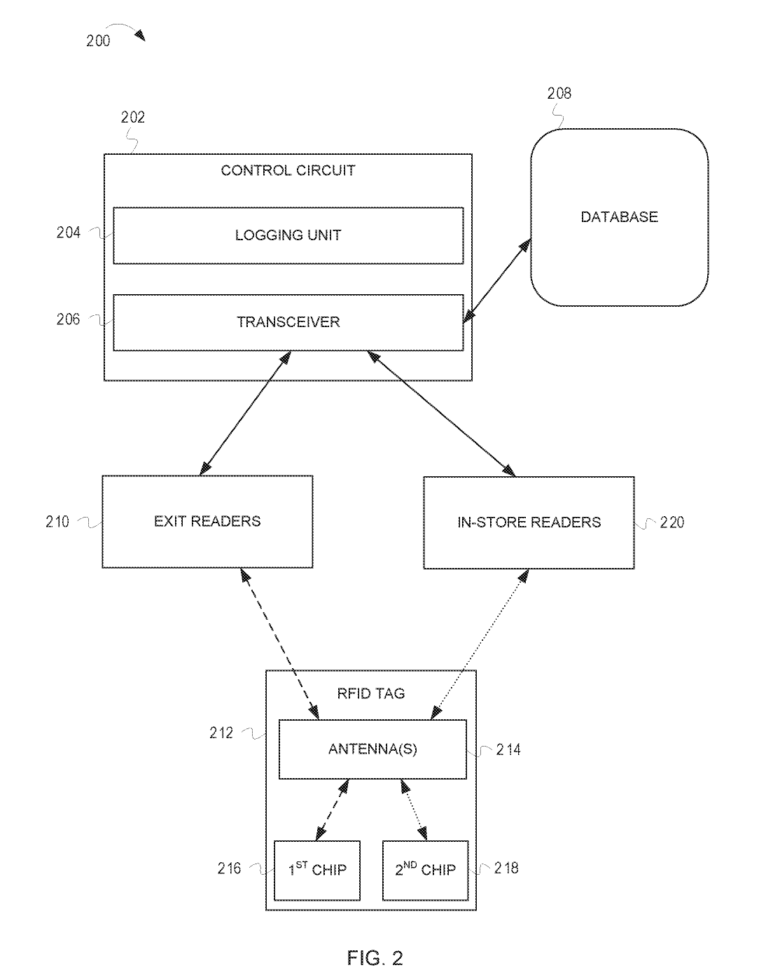

While the discussion of FIG. 1 provides an overview of an RFID tag including two chips, the discussion of FIG. 2 provides additional detail regarding a system for monitoring a product as the product leaves a facility using an RFID tag including two chips.

FIG. 2 is a block diagram depicting a system 200 for monitoring a product as the product leaves a facility. The system 200 includes a control circuit 202, RFID readers (i.e. exit readers 210 and in-store readers 220), an RFID tag 212 (affixed to or otherwise incorporated into a product), and a database 208. The RFID tag 212 includes one or more antennas (such as the antenna 214) and two chips, a first chip 216 and a second chip 218. In some embodiments, the first chip 216 and the second chip 218 are serialized with the same identifier. In such embodiments, the RFID tag 212 is identified identically whether read via a transmission from the first chip 216 or the second chip 218. That is, either read identifies the RFID tag 212 to the system 200.

The first chip 216 is set to a specific filter ID. For example, the first chip 216 can be set to State B of the EPC GEN2 Standard. When set to State B, the first chip 216 will only respond to RFID readers transmitting a request for a response in State B. In a retail facility, the exit readers 210 can be configured to read RFID tags 212 only in State B. The exit readers 210 are located near exits to the facility. Due to this location, when an exit reader 210 reads the RFID tag 212, it can be assumed that the RFID tag 212, and the product with which the RFID tag is associated, has left the facility. As indicated by the dashed arrows, data is transmitted from the first chip 216 to the antenna 214 and then to the exit readers 210.

The second chip 218 can be configured to behave as a typical RFID tag chip would (i.e., switch between states based on read conditions). In an inventory management approach, the second chip can be configured to switch between States A and B (and in some embodiments, between sessions, such as Session 1, 2, and/or 3). The in-store readers 220 are configured as general purpose RFID readers and can read the RFID tag's 212 transmission from the second chip as indicated by the dotted line. By configuring the first chip 216, the second chip 218, the exit readers 210, and the in-store readers 220 in such a manner, the RFID tag 212 can be used for inventory management purposes within the retail facility without inhibiting the ability of the exit readers 210 to read the RFID tag 212 when the product with which the RFID tag 212 exits the store. Such a configuration can eliminate or reduce the number of missed exit scans in a retail facility.

After reading the RFID tag 212, the exit readers 210 and/or the in-store readers 220 transmit an indication of the RFID tag 212 to the control circuit 202. The control circuit 202 includes a transceiver 206. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 202 receives the indication of the RFID tag 212 and logs inventory information regarding the product with which the RFID tag 212 is associated. If the in-store readers 220 read the RFID tag 212, then the RFID tag 212 is in the facility. If the exit readers 210 read the RFID tag 212, then the RFID tag 212 has left the facility. The control circuit 204, via the logging unit, makes this determination and logs the inventory status (e.g., that the product has left the facility) in a database 208. The database 208 can be included within the hardware of the control unit 202, or, as depicted in FIG. 2, a hardware component that is distinct from the control circuit 202. In an inventory management scenario, the database 208 can be in inventory management database.

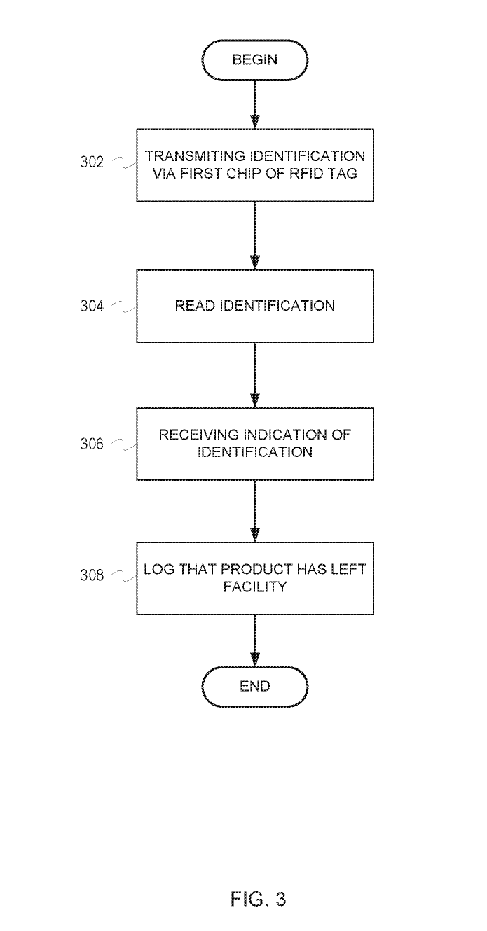

While the discussion of FIG. 2 provides additional detail regarding an inventory management system, the discussion of FIG. 3 describes example operations for monitoring a product as the product leaves a facility using such a system.

FIG. 3 is a flow diagram depicting example operations for monitoring a product as the product leaves a facility, according to some embodiments. In some embodiment, the flow may be performed by the components and systems of one or both of FIGS. 1 and 2 or other suitable variations thereof. The flow begins at block 302.

At block 302, an identification is transmitted via a first chip of an RFID tag. For example, the first chip, of an RFID tag having two or more chips, transmits an identification. In some embodiments, the first chip can be set to a first filter ID. That is, the first chip can be configured to respond only predefined states, such as State B of the EPC GEN2 Standard. The flow continues at block 304.

At block 304, the identification is read. For example, an RFID reader configured to read only RFID tags in the first filter ID reads the identification. The identification can identify the RFID tag and/or a product with which the RFID tag is associated. Such an RFID tag and RFID tag reader can be used for inventory management in a facility, such as a warehouse, a retail facility, a restaurant, an office, etc. In such embodiments, the RFID readers are located near an exit to the facility. Because the RFID tag is set to the first filter ID, the RFID tags state will not be altered by RFID readers that are not set to the first filter ID. Such a configuration will therefore provide accurate monitoring of products as the products leave the facility. The flow continues at block 306.

At block 306, an indication of the identification is received. For example, a control circuit can receive an indication of the identification of the RFID tag from the RFID reader. The indication can identify the RFID tag. Additionally, the indication can identify the RFID reader which detected the RFID tag and/or the RFID reader from which the indication was transmitted. The flow continues at block 308.

At block 308, that the product has left the facility is logged. For example, the control circuit can log that the product has left the facility. In some embodiments, the control circuit logs that the product has left the facility in database, such as an inventory management database.

Generally speaking, pursuant to various embodiments, systems, apparatuses, and methods are provided herein useful to monitoring a product as the product leaves a facility. In some embodiments, a system for monitoring a product as the product leave a facility comprises an RFID tag, wherein the RFID tag is associated with the product, and wherein the RFID tag includes a first chip and a second chip, a first of the two chips set to a first filter ID, an RFID tag reader, the RFID tag reader located near an exit of the facility and configured to read only RFID tags in the first filter ID, and a control circuit communicatively coupled to the RFID tag reader, the control circuit configured to receive, from the RFID tag reader based on a read of the first chip, an indication of the RFID tag, a 3200nd log, based on the indication of the RFID tag, that the product has left the facility.

In some embodiments, an apparatus and a corresponding method performed by the apparatus, comprises broadcasting, via a first chip of an RFID tag comprising a first chip and a second chip, an identification, wherein a first of the two chips is set to a first filter ID, reading, via an RFID tag reader located near an exit of the facility and configured to only read RFID tags in the first filter ID, the identification, receiving, at a control circuit from the RFID tag reader based on a read of the first chip, an indication of the identification, and logging, by the control circuit, that the product has left the facility.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for monitoring a product as the product leaves a facility, the system comprising:
a radio frequency identification (RFID) tag, wherein the RFID tag is associated with the product, wherein the RFID tag includes a first chip and a second chip, and wherein the first chip is set to a first state;
an RFID tag reader, the RFID tag reader located near an exit of the facility and configured to only read RFID tags in the first state; and
a control circuit communicatively coupled to RFID the tag reader, the control circuit configured to:
receive, from the RFID tag reader based on a read of the first chip, an indication of the RFID tag; and
log, based on the indication of the RFID tag, that the product has left the facility.

2. The system of claim 1, wherein the first state is State B of EPC GEN2 Standard.

3. The system of claim 1, wherein the second of the two chips alternates between states.

4. The system of claim 1, wherein the RFID tag includes a single antenna, and wherein the first chip and the second chip are communicatively coupled to the single antenna.

5. The system of claim 1, wherein the RFID tag includes two antennas, and wherein the first chip is communicatively coupled to a first antenna and the second chip is communicatively coupled to a second antenna.

6. The system of claim 1, wherein the facility is a retail facility, wherein the exit of the facility includes a plurality of doors, and wherein the RFID reader includes a plurality of RFID tag readers.

7. The system of claim 1, wherein the first chip and the second chip are serialized with a common identifier.

8. The system of claim 1, further comprising:
a second RFID tag reader, wherein the second RFID tag reader is located near a point-of-sale (POS) terminal and configured to read the second chip.

9. The system of claim 1, wherein the control circuit logs that the product has left the facility in an inventory control database.

10. A method for monitoring a product as the product leaves a facility, the method comprising:
transmitting, via a first chip of a radio frequency identification (RFID) tag comprising the first chip and a second chip, an identification, wherein the first chip is set to a first state;
reading, via an RFID tag reader located near an exit of the facility and configured to only read RFID tags in the first filter ID, the identification;
receiving, at a control circuit from the RFID tag reader based on a read of the first chip, an indication of the identification; and
logging, by the control circuit, that the product has left the facility.

11. The method of claim 10, wherein the first state is State B of EPC GEN2 Standard.

12. The method of claim 10, wherein the second of the two chips alternates between states.

13. The method of claim 10, wherein the RFID tag includes a single antenna, and wherein the first chip and the second chip are communicatively coupled to the single antenna.

14. The method of claim 10, wherein the RFID tag includes two antenna, and wherein the first chip is communicatively coupled to a first antenna and the second chip is communicatively coupled to a second antenna.

15. The method of claim 10, wherein the facility is a retail facility, wherein the exit of the facility includes a plurality of doors, and wherein the RFID reader includes a plurality of RFID tag readers.

16. The method of claim 10, wherein the first chip and the second chip are serialized with a common identifier.

17. The method of claim 10, the method further comprising:
reading, via a second RFID reader located near a point-of-sale (POS) terminal, the second chip.

18. The method of claim 10, wherein the control circuit logs that the product has left the facility in an inventory control database.
